(19) United States
(12) Patent Application Publication
(10) Pub. No.: US 2023/0021343 A1
(43) Pub. Date: Jan. 26, 2023

(54) INVENTORY CONTROL SYSTEM

(71) Applicant: Ramon Ramos, San Antonio, TX (US)

(72) Inventor: Ramon Ramos, San Antonio, TX (US)

(21) Appl. No.: 17/813,461

(22) Filed: Jul. 19, 2022

Related U.S. Application Data
(60) Provisional application No. 63/203,359, filed on Jul. 20, 2021.

(51) Int. Cl. G06Q 10/08

(52) U.S. Cl. CPC G06Q 10/087

(57) ABSTRACT

A method for inventory management that associates a plurality of parts with unique identifiers. A central database that cross-references each of the unique identifiers with corresponding parts. The central database tracking information about parts in remote repositories, each of which has a custodian. The custodians of the repositories having the ability to request parts from other repositories. Each custodian that receives such a request having the option to accept or reject a requested transfer of requested parts. If the custodian receiving the request approves of the transfer, he inputs the unique identifier to indicate approval of the request. After approval from the providing custodian, the custodian receiving the part inputs the unique identifier to acknowledge receipt of the requested part. Every transfer of parts from one custodian to another being documented by each of the providing custodian and the receiving custodian.

### CROSS-REFERENCE TO RELATED APPLICATIONS

This application claims the benefit of the U.S. Patent Ser. No. 63/203,359, filed Jul. 20, 2021, which is incorporated herein by reference in its entirety.

### BACKGROUND OF THE INVENTION

With mobile service and repair services, a consistent and predictable amount of spare parts and inventory is needed. For example, heating, ventilation, and air conditioning (HVAC) repair, mobile repair vehicles will carry with them a certain amount of popular or common replacement parts. Frequently a repair service will have a warehouse that stores a large quantity of parts and a small fleet of mobile repair vehicles that store a subset of those parts. The mobile repair vehicles will frequently transfer repair parts from one to another, depending on the needs of the technician or types of repairs that are needed at that time. This can cause difficulties in tracking inventory and lead to valuable parts becoming lost or inventory shrinkage. Therefore, a system is needed to track the transfer of inventory from the warehouse and/or between mobile repair vehicles.

### SUMMARY OF THE INVENTION

The system uses a database to categorize replacement parts (individually and/or grouped), with the parts each having a unique identifier. The inventory may be stored at a central warehouse and also on mobile repair vehicles. The central warehouse and repair vehicles are considered repositories for parts. The unique identifier is attached to each part and is used to track movement of the part between repositories (mobile repair vehicles and/or the central warehouse). The system uses the unique product identifiers, such as a QR code, along with a handshake protocol when parts are moved between repositories, which prevents parts from becoming lost. Each repository has its own custodian or manager who is in charge of maintaining that respective repository of parts. To move a part between locations, a custodian may request a part from another repository or a custodian may initiate a transfer to another repository. The exchange can be initiated by the requesting repository custodian and the providing repository custodian may approve or reject the proposed transfer. In any transaction within the system, transfers of parts must be approved by the providing repository custodian and acknowledged by the requesting repository custodian with the central database tracking the movement.

### BRIEF DESCRIPTION OF THE DRAWINGS

FIG. 1 is a block diagram overview of the system showing the relationships between repositories and databases;

FIG. 2 is an example screen where a new part is entered into the database;

FIG. 3 shows the pull-down options for the inventory type;

FIG. 4 is an example screen where an existing part is modified or updated;

FIG. 5 is an example screen where a bundled item is created or modified;

FIG. 6 shows the parts contained in the example bundle in FIG. 5;

FIG. 7 shows example bundle details;

FIG. 8 shows an example QR Code or unique identifier;

FIG. 9 shows available parts and closest remote repository;

FIG. 10 shows pending inventory and pending transactions where a custodian of a repository may accept or reject a transfer request;

FIG. 11 shows equipment loaning options;

FIG. 12 shows equipment loaning logs;

FIG. 13 shows an overview with inventory and search options;

FIG. 14 shows an inventory view for a remote repository; and

FIG. 15 shows the main view for the system.

### DETAILED DESCRIPTION OF INVENTION

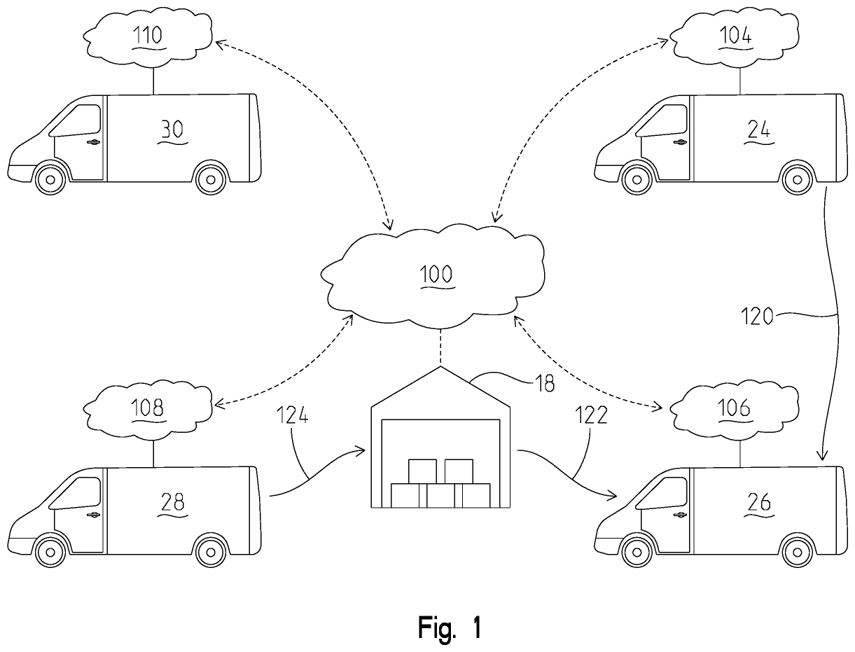

FIG. 1 shows the overall structure of the inventory control system of the present invention. The system is useful for managing inventory when there is a centralized location 18 for storing parts that is often a warehouse but the system does not require a centralized location 18 to operate. The warehouse or centralized location 18 is a repository for parts that will be used in remote repositories for parts 24, 26, 28, 30. The mobile or remote repositories 24, 26, 28, 30 may receive parts from the centralized location 18. Additionally, each of the remote repositories 24, 26, 28, 30 may receive parts from each other or provide parts to each other. In a service business involving work vehicles that are stocked with inventory, the remote repositories 24, 26, 28, 30 are vehicles and the term vehicle will be hereinafter used interchangeably with remote repositories.

As shown in FIG. 1, the system works using a central database 100 which synchronizes with remote databases 104, 106, 108, 110. The remote databases are associated with their respective remote repositories 24, 26, 28, 30. The central database 100 is shown as associated with the centralized location 18 or warehouse, also referred to as a centralized repository 18. Information about the parts is stored in the central database 100 and each unique part has a unique identifier, such as a QR code 32. The information about the parts stored in the central database 100 is described in detail below. Parts can be transferred between remote repositories 24, 26, 28, 30 or between the centralized location 18 and a remote repository 24, 26, 28, 30. All movements of parts are tracked by the central database 100. Each remote database 104, 106, 108, 110 keeps track of the parts present on their corresponding remote repository 24, 26, 28, 30 (respectively labeled in FIG. 1), which is then synchronized with the central database 100. Each repository 24, 26, 28, 30 has its own custodian, who is responsible for inventory and can approve or reject transfers of parts, initiate transfers, receive parts, and transfer parts to and from their repository. A manager of the centralized location 18 is responsible for the parts stored at the centralized location 18. The manager of the centralized location 18 is typically the same person that manages the central database 100 and acts as a custodian for that repository of parts. Parts do not move in or out of any custodian's repository (24, 26, 28, 30 or 18) without the custodian's involvement and approval. The custodian may also be the installer, repair person, or service advisor of the equipment and/or parts.

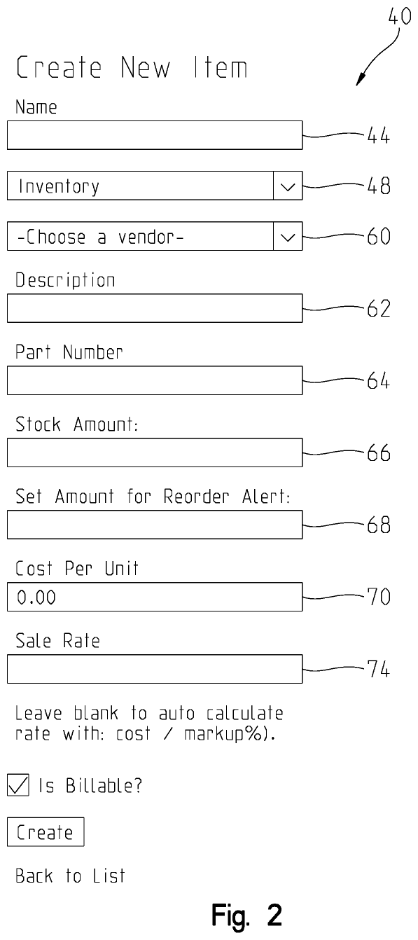

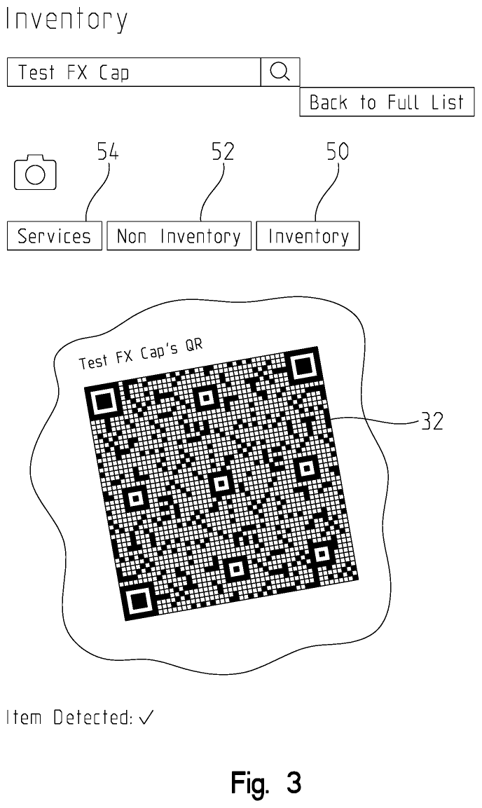

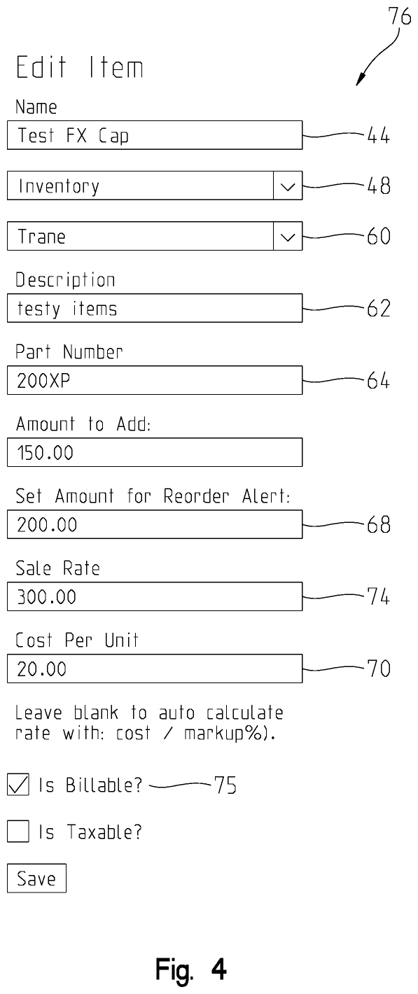

To set up the system, a user must create new items that correspond to parts that will be in the system. Each part will have its own unique identifier 32, which is this case is the QR code 32, and the terms are used interchangeably. The parts are saleable products that will be used in the completion of particular jobs, such as repair or scheduled maintenance. Entering parts into the system is done within the inventory control software via a “create new item” screen 40. The “create new item” screen 40 has several fields that hold information about a particular part. FIG. 2 shows the “create new item” screen 40. Box 44, shown on FIG. 2, is for inputting the name of the part. Box 48 is for inputting what type of part is being described. Box 48 is a drop-down box that has choices for the type of item. The choices a user has for inputting the information required in Box 48 is shown in FIG. 3, which corresponds to the menu screen that appears from Box 48. Those choices include inventory 50, non-inventory 52, and service 54. An inventory part is something that will be sold to a customer and appear on an invoice to that customer. One of the fields may include the cost of the part 70, with this information not visible or available to certain individuals, such as customers. While not required, the goals should be at least to recover the cost for the part and even a possible markup. Noninventory parts are types of consumable parts that are typically not shown on an invoice sent to a customer, but are necessary to complete a job and must be replaced when there is a low inventory of such parts in the system. These parts may be small items such as fasteners, tubing, wire nuts, oil, or standard fittings. Service parts include items such as filters, water pads, or screens. The part or entry may have other fields with attributes that are storable at this time. Returning to FIG. 2, Box 60 contains information for the vendor of the part. Box 62 is for inputting a description of the part. Box 64 is for the part number of the part that is a unique identifier for the part within the system. Box 66 is for the amount of the part in stock at the time the information for the part is entered. At the initial entry of information for the particular part, the stock amount for the part will be contained in box 66, but that amount can change over time. Throughout the use of the system, the stock amount will be altered as parts are added or removed and recorded in the system. The stock amount information is maintained in the central database 100. The central database 100 maintains a total quantity on hand for each part within the entire system in real time. The total quantity of parts within the system also includes the number of parts within the work vehicles or remote repositories 24, 26, 28, 30. Box 68 is for entering a minimum amount for the part at which time that part will need to be reordered. This ensures that a particular part is never out of stock. The warehouse manager, who may also manage the central database 100, decides on an appropriate number for the information in box 68 based on experience and how much of that particular part is used in a certain time. Box 70 is for inputting information about what each unit of the part cost at the time the user of the system purchased that part. The sales rate for each part is input into box 74. This sales rate is the amount paid for the part when the user of the system purchased that particular part plus a certain amount of markup. Settings within the system can determine the extent that certain parts will be marked up and that mark up is stored in the central database 100. If box 74 is left blank, the sales rate for the particular part will be automatically calculated to a price that includes a markup according to information stored in the central database. In other words, adding information into box 74 overrides the system default for markup stored in the central database 100 for a particular part. Check box 75 is a toggle box that is for inputting whether a part is billable to a customer or not. Checking box 75 will cause the part to be billed to a customer when such a part is used to complete a job. After information for each part is entered, that information may be altered as shown in FIG. 4. This is to correct any errors made during initial entry of the information or to update information such as part interchangeability, updated descriptions, specifications, or cost. The editing screen 76 shown in FIG. 4 is much like the “create new item” screen 40 as shown in FIG. 2. Each of the same pieces of information that may be entered in boxes 44, 48, 60, 62, 64, 66, 68, 70, 74, 75 may be altered in the edit screen of FIG. 4. As such, the boxes 44, 48, 60, 62, 64, 66, 68, 70, 74, 75 are labeled accordingly on the edit screen 76 shown in FIG. 4 because they contain the same information, and that information can be changed on the edit screen 76. It is contemplated that the information is entered in a different format, order, or method, as long as the necessary information is stored for each unique part.

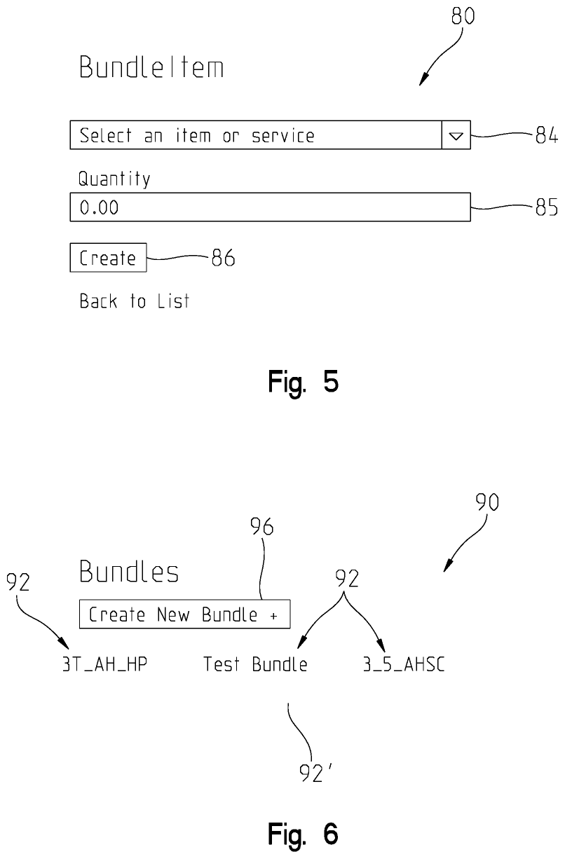

In addition to entering parts individually as shown in FIG. 2, parts may be grouped as bundles, on a bundle entry screen 80. FIG. 5 shows the bundle entry screen 80. Bundles are groups of parts, such as those already entered into the system, that are often used together. For example, if a valve is replaced and standard practice is to replace an upstream filter at the same time, those two parts would be a bundle. Creating a bundle and grouping several existing parts together to make a bundle serves as a shortcut to selecting individual parts on a piecemeal basis. The bundle entry screen 80 is used to select existing parts in the central database 100 and group them together. A drop-down box 84 is a location where the name of a part is entered or selected from a list within the drop-down box 84. The quantity of each part is entered in box 85 and multiple different parts are added to the bundle until it is complete, then the create bundle button 86 is selected to create the bundle having the selected parts. Each bundle may contain not only parts, but may also contain services billed at a particular rate. The services may be provided on a flat fee or hourly basis according to an established labor rate and this information is stored in the central database 100.

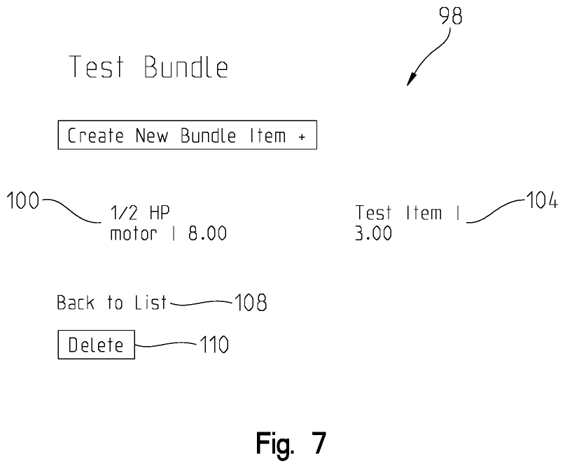

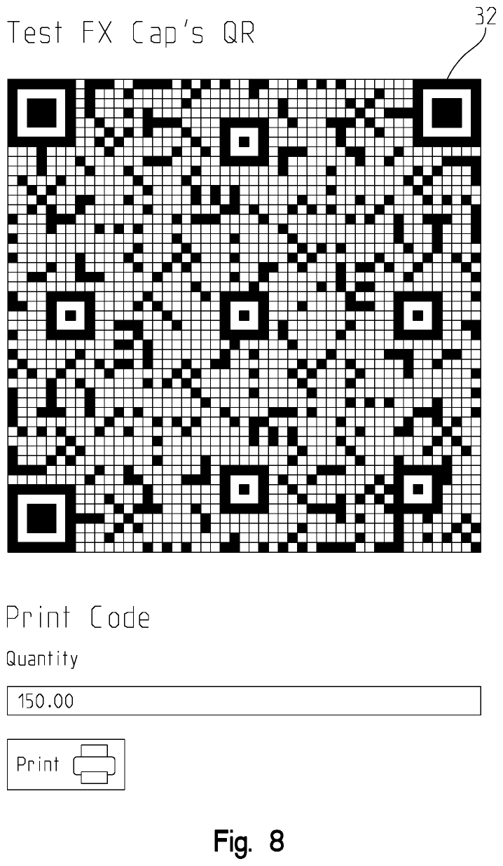

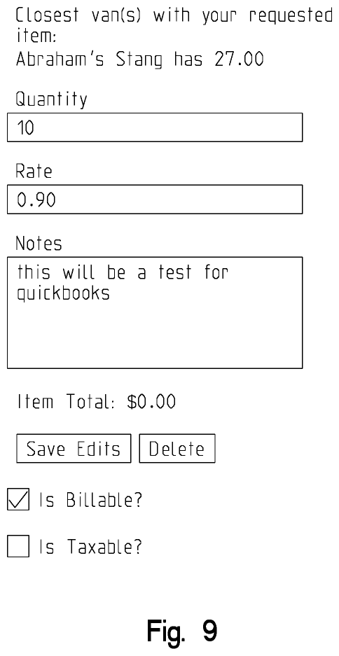

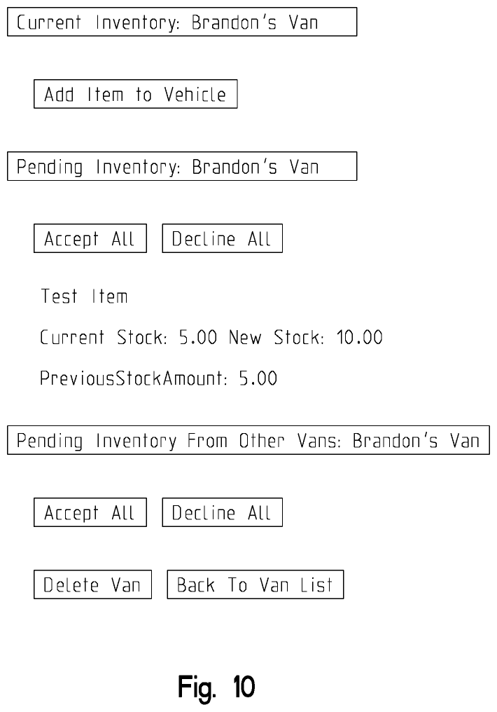

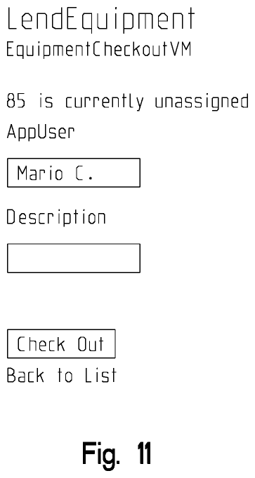

Existing bundles may be viewed on the existing bundle screen 90 as shown in FIG. 6. This provides a listing of existing bundles 92 that may be selected. The existing bundle screen 90 provides the ability to revert back to the bundle entry screen 80 by clicking the “create new bundle” button 96. In the instance of the existing bundle screen 90, as shown in FIG. 6, there are three bundles 92, however, significantly more bundles may be shown. If a bundle such as the Test Bundle 92′ is clicked, doing so will bring a bundle details screen 98 as shown in FIG. 7. The bundle details screen 98 shows the individual components that make up the particular bundle 92′. In the case of the Test Bundle 92′, a ½ HP motor 101, and test item 105 are the components within the Test Bundle 92′. To exit the bundle details screen 98, a user clicks the back to list link 108. A user of the system may also click the delete button 110 to delete the entire bundle.

Once all of the information about a particular part is entered into the central database 100, a QR code 32 may be generated and printed that contains this information. The QR code 32 provides a convenient way for the technician to update the database, transfer inventory, and/or generate invoices for customers. QR codes 32 are applied to items (or packages of those items) so the part can be scanned when moved, installed, or transferred between repositories 24, 26, 28, 30 or the centralized repository 18.

Once parts are loaded into the system, an inventory transfer can be initiated by either scanning a QR code 32 or searching the inventory in the system and selecting it. The custodian from the providing repository or the receiving repository can initiate a transfer. This is analogous to a “pull” system, where a requesting custodian needs a part and requests it from other repositories, or a “push” system, where a custodian needs to transfer a part to another repository and initiates a transfer. An example of a push type transaction may be the central repository 18 initiating a request to deposit parts into one of the remote repositories 24, 26, 28, 30 in the case where the manager of the central repository 18 notices low inventory in one or more remote repositories 24, 26, 28, 30. Irrespective of how the transfer is initiated, both custodians must be involved to complete the transfer.

Where there are multiple remote repositories 24, 26, 28, 30, many of the remote repositories 24, 26, 28, 30 could contain a certain quantity of a desired part, along with the centralized location 18. When a remote repository 24, 26, 28, 30 is lacking a part needed to complete a service call, that remote repository's custodian can send a request for the desired part. Each remote repository 24, 26, 28, 30 has its own inventory which is synchronized with the central database 100. Requesting custodians can either send out a general request for the part or request a transfer from a specific repository.

The central database 100 also knows the location of the remote repositories 24, 26, 28, 30, typically through GPS, and can allow or reject requests from certain remote repositories 24, 26, 28, 30, depending on inventory level of that part at that particular repository, the proximity of that repository to the requesting custodian, or if the requested part in the repository is earmarked for a specific service call. This functionality ensures that unnecessary driving between repositories 24, 26, 28, 30 located relatively far apart will be eliminated and that parts will be obtained from the closest available source. In the event of a general request, the central database 100 may provide repository options to the requesting custodian, along with notifying the custodians from the repositories having the part in question that a request is pending. The central database 100 reports the availability of the requested part and the corresponding repositories that contain the requested part. At this stage, the requesting custodian may decide which of the repositories he wants to obtain the part from and upon the requesting custodian's selection of which repository to take the part from, that selected repository shall become the pending providing repository. The custodian at the pending providing repository has the option to approve or reject the request from the requesting custodian. In a push type transaction as described above (such as a transaction initiated at the central repository 18) the pending providing repository may be the central repository 18 until a remote repository 24, 26, 28, 30 approves the receipt of the parts in the proposed transfer. Although in a push transaction the remote repository 24, 26, 28, 30 did not initiate the request, the corresponding remote repository 24, 26, 28, 30 that is to receive the parts takes the same role in the transaction as a requesting custodian because that corresponding custodian is a receiving custodian that will be acquiring the parts. All requests and approvals/rejections are communicated through the synchronization between the remote databases 104, 106, 108, 110 and central database 100. Once the custodian at the pending providing repository accepts the request for the part, the pending providing repository becomes a providing repository. If a custodian at a pending providing repository denies transfer of a requested part, the requesting custodian is notified to select another repository having the part. That denial of a transfer request is communicated from the pending providing repository through the central database 100 and back to the requesting custodian. For part transfers that are approved, that custodian at the providing repository scans the unique identifier (QR code) 32 of the requested part to input his intent into the central database 100. The requested part changes hands from the providing custodian to the requesting custodian, and at that time, the requesting custodian “receives” the requested part by scanning the unique identifier. The remote databases 104, 106, 108, 110 are updated along with the central database 100, such as the quantity of parts contained in each, which completes the transfer from the providing repository to the receiving repository corresponding to the requesting custodian. A record of location for the requested part is made to indicate that it has moved into the repository of the requesting custodian. Also, the time and date of the transfer for the requested part is noted in the central database 100. The process is the same if the part is being transferred to or from the centralized warehouse 18. In this manner the providing custodian has the inventive to document a part that is leaving his repository 24, 26, 28, 30 so that he may document the flow of parts from his repository. The receiving custodian has an incentive to document his receipt of the part in a nearly simultaneous transaction because the receiving custodian knows that the providing custodian has left a record in the central database 100 showing that receiving custodian should have the part. It is this handshake type methodology that ensures parts are not lost and shrinkage is eliminated. Although the providing custodian records the first part of the transfer slightly before the receiving party scans to indicate is receipt of the part, all parties involved are well aware that their actions are being documented. This process streamlines inventory control. Some examples showing the transfer of parts between the central location 18 and repositories 24, 26, 28, 30 and between repositories are shown in FIG. 1. Examples include a transfer from remote repository 24 to remote repository 26 by arrow 120, or a transfer from the central location 18 to remote repository 26 by arrow 122, or a transfer from a remote repository 28 to the central location 18 by arrow 124.

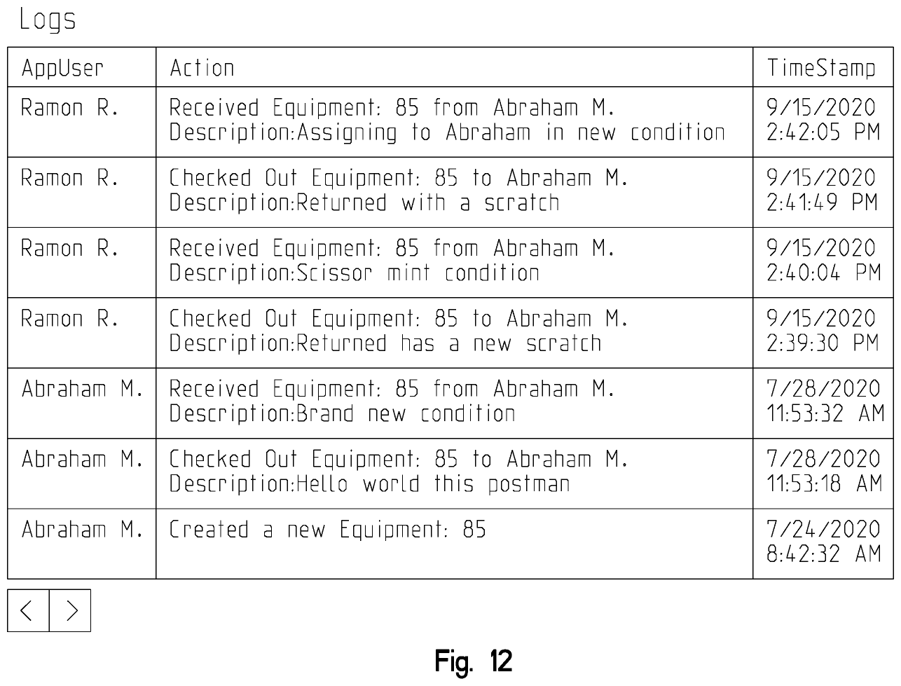

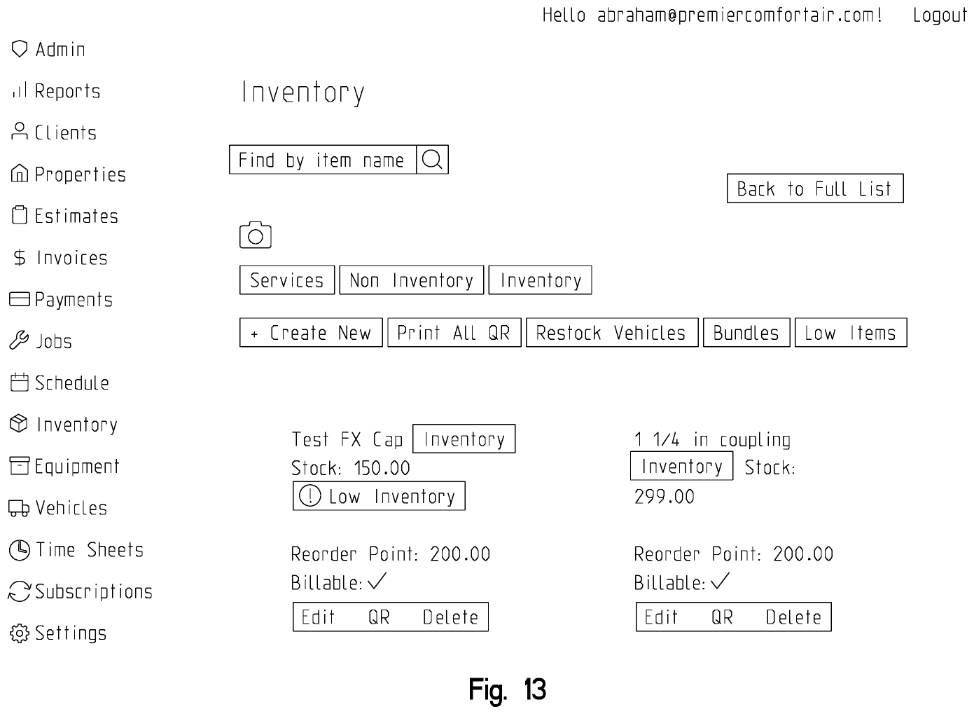

As shown in FIG. 11, the system includes the provision to loan tools between repositories. Some tools are specialized, expensive, and are not necessary to have one for each repair vehicle. As with any asset that gets passed around between different users, the condition of the tool can become an issue. The centralized database 100 tracks the users and any noted damage observed when the tool changes hands. The process to loan/borrow a tool is the same as with the transfer of a part but also includes a section where damage or issues can be documented. The history of the users of that tool is logged in the central database 100, as shown in FIG. 12.

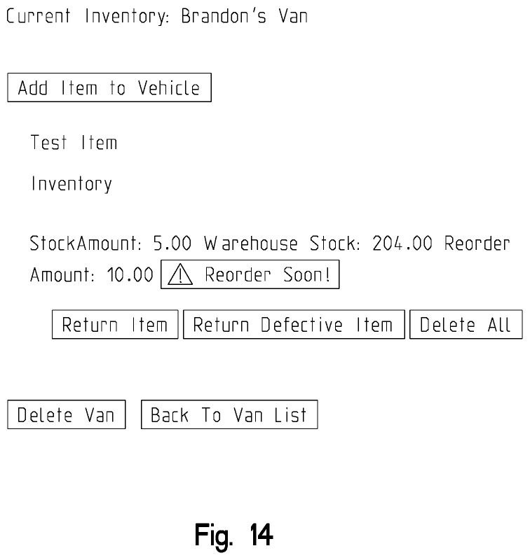

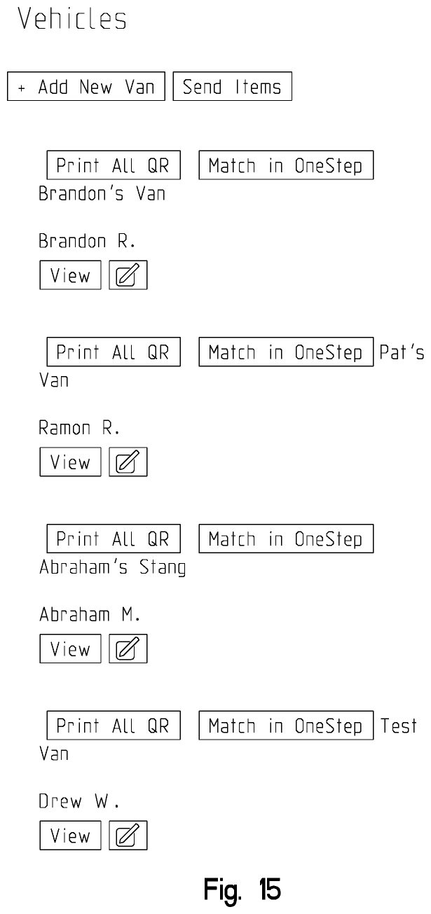

Because the centralized database 100 keeps track of all inventory, the database 100 can be programmed to alert custodians (central or remote) that inventory is running low and more should be ordered, as shown on FIG. 14. The reorder quantity 68 is shown in FIG. 2. This also applies for stocked parts in the remote repositories. If the inventory of a particular part in the remote repository 24, 26, 28, 30 drops below a specified limit, the system can be programmed to either alert the remote custodian and/or the centralized custodian to initiate a transfer, similar to the “push” type of transfer described above.

When a part is used for a service call, the system is used to maintain and monitor inventory levels in the remote repositories, along with generating invoices for the service call. When a part is removed from inventory at the remote repositories (aside from a transfer to another repository), the part unique identifier (QR code) 32 is scanned by the custodian with the transfer from inventory being for a specific job. The scanning of the QR code 32 and database recognition of the part is shown in FIG. 3. This allows the proper invoicing of parts and materials for service calls, repairs, or the like.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A method for inventory management comprising the steps of:
providing a plurality of parts, each of said parts having a corresponding unique QR code associated therewith;
providing a central database that cross-references each said unique QR code to information about said part associated therewith;
providing a plurality of repositories for said parts, one of said repositories being a central repository, the other said repositories being remote repositories;
providing a manager of said central database;
providing custodians for each of said repositories;
providing a corresponding remote database for each of said remote repositories, each said remote database synchronized with said central database;
when one of said custodians request one of said parts stored in one of said repositories, said central database reporting availability of said requested part and the corresponding repositories associated therewith;
said requesting custodian deciding which said repository to become a pending providing repository to provide said requested part;
said requesting custodian requesting a transfer of said requested part from said pending providing repository to said requesting custodian;
said custodian of said pending providing repository choosing to approve or deny said transfer request of said requesting custodian;
if said custodian of said pending providing repository approves said transfer request, said pending providing repository becomes a providing repository, said custodian of said providing repository scanning said unique QR code of said requested part to indicate an intended transfer of said requested part to said requesting custodian;
if said custodian of said pending providing repository denies said transfer request, said requesting custodian is notified that said request is denied and for said requesting custodian to choose another said repository to become said pending providing repository;
said requesting custodian receiving physical custody of said requested part from said custodian of said providing repository and scanning said unique QR code of said requested part to acknowledge transfer of said requested part into said repository of said requesting custodian and database of said requesting custodian; and
said central database updating a quantity of said requested part in said providing repository and said repository of said requesting custodian.

2. The method of claim 1, wherein the updating of said central database includes the steps of decrementing said quantity of said requested part within said providing repository and increasing said quantity of said requested part in said repository of said requesting custodian upon said acceptance by said requesting custodian, creating a record of location for said requested part indicating that said requested part is located in said repository of said requesting custodian.

3. The method of claim 1, further comprising the step of providing a second custodian of a second remote repository for said parts, said second remote repository having a second remote database, providing the capacity for said second custodian of said second remote repository to request one of said parts held by said custodian of said remote repository and providing the capacity for said second custodian of said second remote repository to request one of said parts held by said central repository.

4. The method of claim 3, wherein a date and time are recorded corresponding to said when said one part has changed location from said remote repository for said parts to said second remote repository for said parts within said central database.

5. The method of claim 1, wherein a date and time are recorded within said central database corresponding to when said one part was accepted by said custodian of said remote repository for said parts.

6. A method for inventory management comprising the steps of:
providing a plurality of parts, each of said parts having a corresponding unique QR code associated therewith;
providing a central database that cross-references each said unique QR code to information about said part associated therewith;
providing a plurality of repositories for said parts;
providing corresponding custodians for each of said repositories;
providing a corresponding remote database for each of said repositories, each said remote database synchronized with said central database;
when one of said custodians request one of said parts stored in one of said repositories, said central database reporting availability of said requested parts and corresponding said repositories associated therewith;
said requesting custodian deciding which said repository to provide said requested part and become a pending providing repository;
said requesting custodian requesting a transfer of said requested part from said pending providing repository to said requesting custodian, said requesting custodian's repository becomes a receiving repository;
said custodian of said pending providing repository choosing to approve or deny said transfer request of said requesting custodian;
if said custodian of said pending providing repository approves said transfer request, said pending providing repository becomes a providing repository, said custodian of said providing repository scanning said QR code of said requested part to indicate an intended transfer of said requested part to said custodian of said receiving repository;
if said custodian of said pending providing repository denies said transfer request, said requesting custodian is notified that said request is denied and for said requesting custodian to choose another said repository to become said pending providing repository;
said requesting custodian receiving physical custody of said requested part from said custodian of said providing repository and scanning said QR code of said requested part to acknowledge transfer of said requested part into said receiving repository and database of said requesting custodian; and
said central database updating a quantity of said requested part in said providing repository and said repository of said requesting custodian.

7. The method of claim 6, wherein one of said repositories is a central repository, the other said repositories are remote repositories, further providing a manager for said central database, said manager having supervisory authority over said transfer requests of said requested parts.

8. The method of claim 6, wherein a date and time are recorded corresponding to when said one part has changed location.

9. A method for inventory management comprising the steps of:
providing a plurality of parts, each of said parts having a corresponding unique identifier associated therewith;
providing a central database that cross-references each said unique identifier to information about said part associated with said unique identifier;
providing a plurality of repositories for said parts, one of said repositories being a central repository, the other said repositories being remote repositories;
providing a manager of said central database;
providing custodians for each of said repositories;
providing a corresponding remote database for each of said remote repositories, each said remote database synchronized with said central database;
when one of said custodians request one of said parts stored in one of said repositories, said requesting custodian receiving information on the availability of said requested part and the corresponding repositories associated requested part;
said requesting custodian deciding which said repository to become a pending providing repository to provide said requested part;
said requesting custodian requesting a transfer of said requested part from said pending providing repository to said requesting custodian;
said custodian of said pending providing repository choosing to approve or deny said transfer request of said requesting custodian;
if said custodian of said pending providing repository approves said transfer request, said pending providing repository becomes a providing repository, said custodian of said providing repository inputting said unique identifier of said requested part to indicate an intended transfer of said requested part to said requesting custodian;
if said custodian of said pending providing repository denies said transfer request, said requesting custodian is notified that said request is denied and for said requesting custodian to choose another said repository to become said pending providing repository;
said requesting custodian receiving physical custody of said requested part from said custodian of said providing repository and inputting said unique identifier of said requested part to acknowledge transfer of said requested part into said repository and database of said requesting custodian; and
said central database updating a quantity of said requested part in said providing repository and said repository of said requesting custodian.

10. The method of claim 9, wherein said central database notifies said requesting custodian of availability of said requested part.

11. The method of claim 10, wherein said manager of said central database is said custodian of said central repository.

12. The method of claim 9, wherein inputting said unique identifier is done by scanning said unique identifier.

13. The method of claim 12, wherein said unique identifier is a QR code.

14. The method of claim 13, wherein said central database notifies said requesting custodian of the availability of said requested part.
